(19) United States
(12) Patent Application Publication
(10) Pub. No.: US 2009/0089119 A1
(43) Pub. Date: Apr. 2, 2009

(54) Method, Apparatus, and Software System for Providing Personalized Support to Customer

(75) Inventor: Rakesh Ranjan, San Jose, CA (US)

Correspondence Address: Walder Intellectual Property Law PC, 17330 Preston Road, Suite 100B, Dallas, TX, 75252, US

(73) Assignee: IBM Corporation

(21) Appl. No.: 11/866,127

(22) Filed: Oct. 2, 2007

(51) Int. Cl. G06Q 10/00; G06F 17/40; G06F 19/00

(52) U.S. Cl. 705/7

(57) ABSTRACT

A software agent gathers data concerning customer usage of a software product, including error information and other relevant information. A support server gathers customer usage data and determines which optional features of a product are being used, or not being used, by the customer. The developer may then determine what features and functionalities of a product are critical for each individual customer or group of customers. The support server may generate a personalized support system for each customer or group of customers based on the gathered information. The support server may create a segment of customers within vertical industry segments and target the customers with new and advanced features to help solve their individual business problems. Customers may access personalized support pages based on their usage data.

### BACKGROUND

1. Technical Field

The present application relates generally to an improved data processing system and method. More specifically, the present application is directed to a method, apparatus, and software system for providing personalized support to a customer.

2. Description of Related Art

An enterprise class product, such as a database product or business integration infrastructure, may have many features. A small percentage of optional features in these products may be used by any given customer. As open source adoption increases, commercial product vendors have more pressure to release products and features in a short time period and with great quality.

Web based businesses have been very successful in capturing user behavior and usage of products and services. From this information, businesses may determine a pattern in user behavior and product usage to launch and market new products and services. Web logs (blogs), reviews, and other features may be used to capture valuable customer feedback to improve products and services even further.

Traditional software products implement a reactive customer support approach, where developers respond to bugs and problems found by customers by giving the customers patches and application updates. This approach tends to be time consuming, expensive, and very often does little to avoid customer dissatisfaction. Code changes in features must be tested very thoroughly to minimize the impact.

### SUMMARY

The illustrative embodiments recognize the disadvantages of the prior art and provide a proactive approach to software product support. A software agent gathers data concerning customer usage of a software product, including error information and other relevant information, referred to herein as metadata information. A support server gathers customer usage data and determines which optional features of a product are being used, or not being used, by the customer. The support server may then determine what features and functionalities of a product are critical for each individual customer or group of customers. The support server may generate a personalized support system for each customer or group of customers based on the gathered information. Known bugs or fixes or added features may be proactively sent to customers before bugs and errors are reported to the vendor. The support server may create a segment of customers within vertical industry segments and target the customers with new and advanced features to help solve their individual business problems. Customers benefit by having fixes and features developed and distributed proactively. Customers may also get personalized support pages based on their usage data.

In one illustrative embodiment, a method in a data processing system for providing personalized support comprises receiving usage data from a customer of a software application, analyzing the usage data based on a set of rules, identifying a support action based on the analysis of the usage data, and performing the identified support action based on the usage data.

In one exemplary embodiment, the usage data comprises at least one of file access information, feature access information, or error information.

In another exemplary embodiment, the support action comprises generating a software update. In a further exemplary embodiment, the software update comprises a patch. In a still further exemplary embodiment, performing the support action comprises distributing the software update to the customer.

In yet another exemplary embodiment, the support action comprises generating a personalized support page. In a further exemplary embodiment, the personalized support page comprises a personalized support Web page. The method further comprises providing access to the personalized support Web page through a Web server. In a still further exemplary embodiment, the personalized support page comprises information about at least one of alternative product features, appropriate parts of a user guide or administration guide, available user or application developer training, or related forums where people are collaborating on a same topic of interest.

In another exemplary embodiment, analyzing the usage data comprises performing data mining and correlation to identify significant data and relationships.

In yet another exemplary embodiment, identifying a support action comprises determining what features and functionalities of the software application are critical for an individual customer or group of customers.

In still another exemplary embodiment, receiving usage data from a customer of a software application comprises receiving the usage data from a software agent associated with the software application.

In another illustrative embodiment, a data processing system for providing personalized support comprises a processor and a memory coupled to the processor. The memory contains instructions which, when executed by the processor, cause the processor to receive usage data from a customer of a software application, analyze the usage data based on a set of rules, identify a support action based on the analysis of the usage data, and perform the identified support action based on the usage data.

In one exemplary embodiment, the support action comprises generating a software update. In a further exemplary embodiment, the software update comprises a patch.

In another exemplary embodiment, the support action comprises generating a personalized support page. In a further exemplary embodiment, the personalized support page comprises a personalized support Web page. The instructions further cause the processor to provide access to the personalized support Web page through a Web server.

In yet another exemplary embodiment, receiving usage data from a customer of a software application comprises receiving the usage data from a software agent associated with the software application.

In a further illustrative embodiment, a computer program product comprises a computer useable medium having a computer readable program. The computer readable program, when executed on a computing device, causes the computing device to receive usage data from a customer of a software application, analyze the usage data based on a set of rules, identify a support action based on the analysis of the usage data, and perform the identified support action based on the usage data.

In one exemplary embodiment, the support action comprises generating a software update.

In another exemplary embodiment, the support action comprises generating a personalized support page.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary representation of an exemplary distributed data processing system in which aspects of the illustrative embodiments may be implemented;

FIG. 2 is a block diagram of an exemplary data processing system in which aspects of the illustrative embodiments may be implemented;

FIG. 3 is a block diagram illustrating a system for providing personalized support to customers in accordance with an illustrative embodiment;

FIG. 4 is a block diagram depicting the operation of a usage tracking software agent in accordance with an illustrative embodiment;

FIG. 5 is a block diagram depicting the operation of a support server in accordance with an illustrative embodiment;

FIG. 6 is a flowchart illustrating operation of a usage tracking software agent in accordance with an illustrative embodiment; and

FIG. 7 is a flowchart illustrating operation of a support server in accordance with an illustrative embodiment.

### DETAILED DESCRIPTION OF THE ILLUSTRATIVE EMBODIMENTS

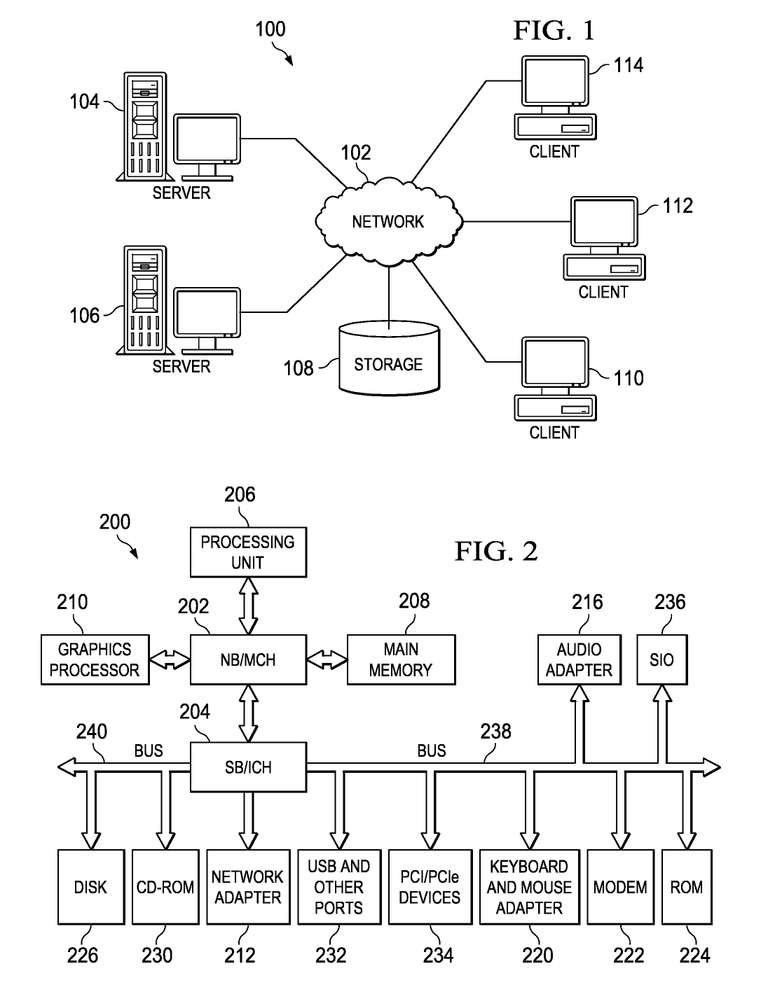

With reference now to the figures and in particular with reference to FIGS. 1 and 2, exemplary diagrams of data processing environments are provided in which illustrative embodiments of the present invention may be implemented. It should be appreciated that FIGS. 1 and 2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In one illustrative embodiment, server 104 may provide a support server application that gathers usage data and metadata information from software agents associated with a product. The product may be a software product running on a server, such as server 106, or a client, such as one of clients 110-114. The software agent is associated with the software product and collects information concerning features being accessed, error information, file access information, and other information (metadata information), such as customer configuration and data processing environment information. The software agent then sends this collected information either periodically or in response to some event, such as a critical error, for example. Alternatively, support server 104 may poll the software agent to gather the information.

A patch is a fix to an executable program. As used herein, a patch means an update to an actual executable, which often may mean replacing an executable module in its entirety. A software update, as used herein, may be an update to the application including support files, such as graphic objects, configuration files, plug-in modules, help files, and so forth. A software update may comprise a patch.

With the gathered information, support server 104 may generate personalized support pages or patches or updates that are customized for the particular customer. As a particular example, personalized support pages may be stored in storage 108, and a Web server, such as server 106, may provide access to the pages as Web pages. A customer may then access the personalized support Web pages to learn about alternative product features, appropriate parts of the user guide or administration guide, available user or application developer training, related forums on the Web where people are collaborating on the same topic of interest, and so forth.

Support server 104 may also generate patches or software updates that affect features that are critical to customers or are frequently used. In the prior art, developers may be left to guess about what features are critical or popular. A developer in the prior art may update one particular feature while customers are experiencing problems with a different feature altogether. The developer may learn about the problems well into the patch or update development process. In accordance with the illustrative embodiment, support server 104 gathers actual usage data and metadata information that allows the software developer to concentrate on patches or updates that are actually useful to the customers. Furthermore, support server 104 may generate patches or updates that are precisely targeted to particular customers.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as hosts 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

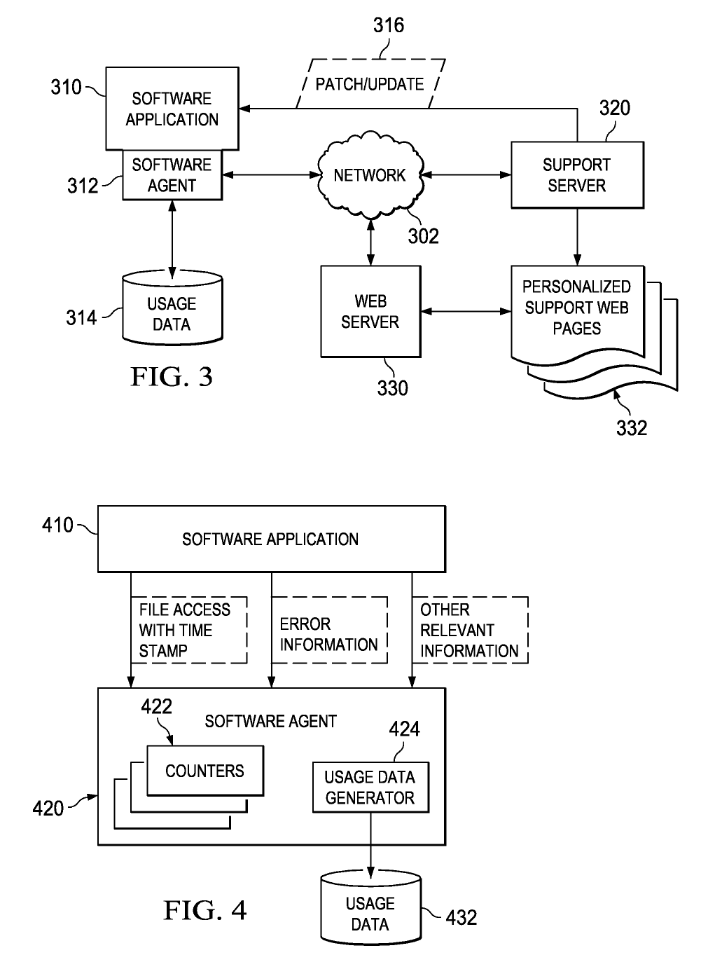

With reference now to FIG. 3, a block diagram is shown illustrating a system for providing personalized support to customers in accordance with an illustrative embodiment. A software developer provides software application 310 to a customer. Software application 310 may comprise one or more executable files and support files, such as graphic objects, configuration files, ancillary data files, help files, and the like. Software application 310 may also comprise many features, some of which may not be used by a particular customer while others may be used heavily by the customer.

Software agent 312 is associated with software application 310. In an alternative embodiment, software agent 312 may be associated with a whole group of applications. Such a group of software applications may be, for example, a software suite or family or a business integration infrastructure. Software agent 312 communicates with software application 310 and gathers usage data 314. Usage data 314 may be, for example, files and/or features that are accessed by the user, error information, and other information that may be relevant to further development or support of software application 310. Software agent 312 may be a component of software application 310, such as a plug-in module, or may be a standalone application that communicates with software application 310.

Software agent 312 communicates with support server 320 via network 302. In one particular embodiment, network 302 may be the Internet, which is a worldwide collection of networks and gateways that use the Transmission Control Protocol/Internet Protocol (TCP/IP) suite of protocols to communicate with one another. Software agent 312 may send usage data 314 to support server 320 periodically, such as once a day or once an hour, for example. Alternatively, software agent 312 may send usage data 314 to support server 320 in response to a given event, such as a critical error, for example. In an alternative embodiment, support server 320 may poll software agent 312, periodically or in response to a given event, to gather usage data 314.

Support server 320 generates patch/update 316 for software application 310. Support server 320 may distribute patch/update 316 via network 302. Support server 320 may generate patch/update 316 particularly for a given customer or group of customers based on usage data 314. For example, patch/update 316 may affect a feature that the customer uses frequently or is critical to the customer, as can be gleaned from usage data 314. Support server 320 may update or patch the software agent itself.

Support server 320 may also generate personalized support Web pages 332. In the depicted example, Web server 330 provides access to personalized support Web pages 332 via network 302. The customer may then access personalized support Web pages 332 to learn about alternative product features, appropriate parts of the user guide or administration guide, available user or application developer training, related forums on the Web where people are collaborating on the same topic of interest, and so forth.

As an example, in the DB2® viper pure-XML product from International Business Machines Corporation, in the financial industry, a particular customer may create database indexes in a particular pattern. Support server 320 may use usage data 314 to determine these patterns and generate query plans that can boost xquery (W3C Query language for XML data) performance. Thus, support server 320 may target a segment of customers with new services and solutions that are personalized to their requirements and usage.

FIG. 4 is a block diagram depicting the operation of a usage tracking software agent in accordance with an illustrative embodiment. A software developer provides software application 410 to a customer. Software application 410 may comprise one or more executable files and support files, such as graphic objects, configuration files, ancillary data files, help files, and the like. Software application 410 may also comprise many features, some of which may not be used by a particular customer while others may be used heavily by the customer.

Software agent 420 is associated with software application 410. In an alternative embodiment, software agent 420 may be associated with a whole group of applications. Such a group of software applications may be, for example, a software suite or family or a business integration infrastructure. Software agent 420 communicates with software application 410 and receives information concerning actual usage of software application 410. For instance, software agent 420 may receive information concerning each file access with a time stamp, error information, and other relevant (metadata) information. Software agent 420 may be a component of software agent 410, such as a plug-in module, or may be a standalone application that communicates with software application 410.

Software agent 420 comprises counters 422, which software agent 420 may use to count the number of times software application 410 accesses particular files or features. Software agent 420 also comprises usage data generator 424, which generates usage data 432. Usage data 432 may comprise, for example, files and/or features that are accessed by the user, error information, and other information that may be relevant to further development or support of software application 410. Usage data gathered from hundreds or thousands of customers, or perhaps more, can provide the software developer valuable data for mining, which enable the developer to provide better support.

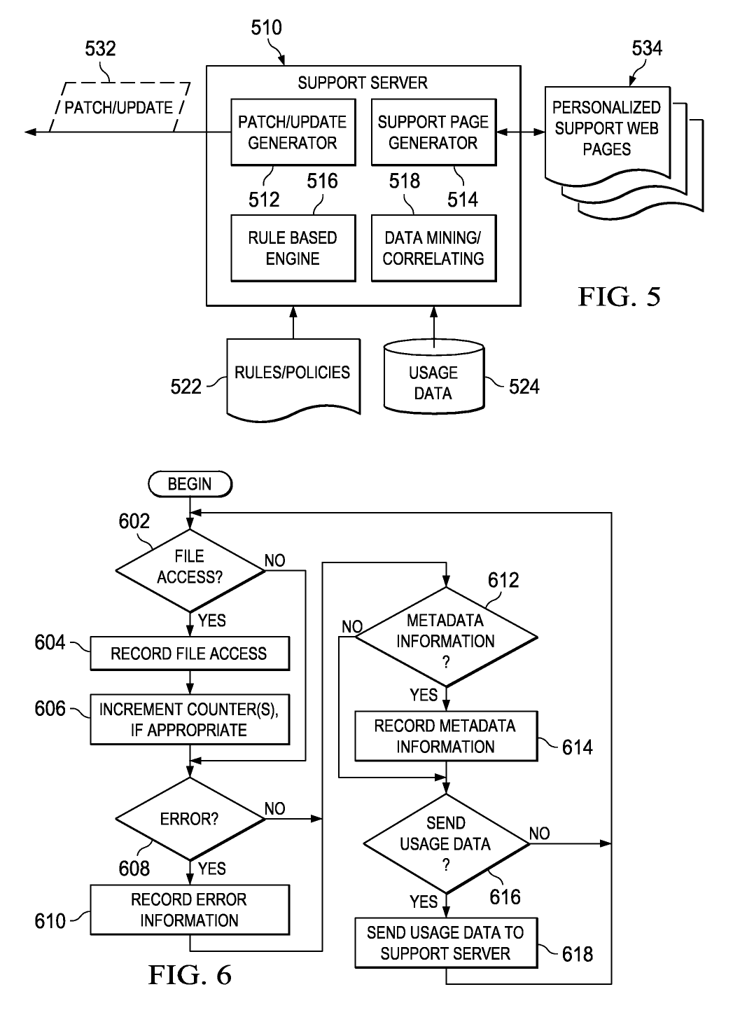

FIG. 5 is a block diagram depicting the operation of a support server in accordance with an illustrative embodiment. Support server 510 communicates with usage tracking software agents. Support server 510 comprises rule based engine 516. Rule based engine 516 uses “if-this, do that” rules and policies, which in some cases may be a complex algorithm to perform actions. Rule based engine 516 provides flexibility in support server 510, enabling tasks and data to be easily changed by replacing one or more rules in rules/policies 522.

Support server 510 comprises data mining/correlating component 518, which explores and analyzes usage data 524. Data mining/correlating component 518 uncovers patterns and relationships contained within usage data 524. As an example, if several customers experience the same patterns of usage, support server 510 may target support to that group of customers. As another example, data mining/correlating component 518 may discover relationships between feature usage and particular errors.

Support server 510 comprises patch/update generator, which generates patch/update 532. Patch/update generator 512 may generate patch/update 532 particularly for a given customer or group of customers based on rules/policies 522 and usage data 524. For example, patch/update 532 may affect a feature that the customer uses frequently or is critical to the customer, as can be gleaned from usage data 524.

Support server 510 comprises support page generator 514, which generates personalized support Web pages 534. Customers may then access personalized support Web pages 534 to learn about alternative product features, appropriate parts of the user guide or administration guide, available user or application developer training, related forums on the Web where people are collaborating on the same topic of interest, and so forth.

The support system of the illustrative embodiments may also market new features or options based on the customer's usage of the product, similar to the way online retailers market products based on past purchase history. For example, if a DB2® 9 database application customer heavily uses extensible markup language (XML) decomposition to store XML data back to relational tables and uses structured query language (SQL) XML instead of the XQUERY feature, then such usage information may be useful to the developer. From the usage data, the developer may determine that the customer is comfortable with the SQL standard and skills, and may lack XQUERY skills, or the customer demands high performance queries where the XQUERY feature may not perform well. If adoption of XQUERY is critical for the success of a pure-XML database product, then International Business Machines Corporation may suggest various optimization techniques to ensure that XQUERY performs equally well or better than SQL. Through the support system of the illustrative embodiments, a company can market necessary education, training, and underused features to ensure its product is being used to its full potential.

As another example, a customer may use DB2® database to use the pure-XML database. The customer may judge the quality of the product on the bases of how the application queries perform on XML data stored in the database or how efficient the system is in inserting and retrieving XML data. However, the application performance may depend on multiple database administration tasks, such as how tables were created and managed in tablespaces or the actual page size itself. When a user creates a table to store a very large XML file in a single tablespace, the usage tracking software agent may read the catalogs and store relevant information in the usage data. When the rule based engine processes the usage data, the support server may generate a recommendation for the user on how the tables should be created and how the page size should be managed. The support server may also suggest an appropriate part of the user guide or administration guide for the user to read. The support server could also suggest training for the user or application developer, or point to related forums on the Web where people are collaborating on the same topic of interest. Thus, the product support system in the illustrative embodiments does more than simply provide an index advisor or wizard to suggest how to create indexes. The support system described herein provides very personalized support based on the customer's actual usage of the product.

FIG. 6 is a flowchart illustrating operation of a usage tracking software agent in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

Furthermore, the flowcharts are provided to demonstrate the operations performed within the illustrative embodiments. The flowcharts are not meant to state or imply limitations with regard to the specific operations or, more particularly, the order of the operations. The operations of the flowcharts may be modified to suit a particular implementation without departing from the spirit and scope of the present invention.

With reference now to FIG. 6, operation begins, and the usage tracking software agent determines whether there is an access of a file or feature (block 602). The usage tracking software agent communicates with the software application and receives an indication when a file or feature of the application is accessed. If there is a file or feature access in block 602, the usage tracking software agent records the file access with a timestamp (block 604). Then, the usage tracking software agent increments a counter, if appropriate (block 606). The usage tracking software agent may count the number of times the customer accesses particular files or features using counters.

Thereafter, or if there is not an access of a file or feature in block 602, the usage tracking software agent determines whether an error indication is received (block 608). If an error indication is received, the usage tracking software agent records the error information (block 610). The error information may include the error itself, as well as configuration and environment information that may be relevant to the error.

Thereafter, or if an error indication is not received in block 608, the usage tracking software agent determines whether metadata information is received from the software application (block 612). This metadata information may represent key information for providing product support. For example, if the executable file corresponding to “create index” was used or accessed, then gathering the catalogs/configurations to know information such as type and size of index are valuable data. The software application may notify the software agent of other information, such as changes to configuration information or preferences and the like. If the usage tracking software agent receives metadata information in block 612, the usage tracking software agent records the metadata information in the usage data (block 614).

Thereafter, or if metadata information is not received in block 612, the usage tracking software agent determines whether to send the usage data to the support server (block 616). The software agent may send the collected usage data periodically or in response to some event, such as a critical error, for example. Alternatively, the support server may poll the software agent to gather the usage data. If the usage tracking software agent determines that usage data is to be sent, the usage tracking software agent sends the usage data to the support server (block 618). Thereafter, or if the usage tracking software agent determines not to send usage data in block 616, operation returns to block 602 to determine whether a file or feature is accessed.

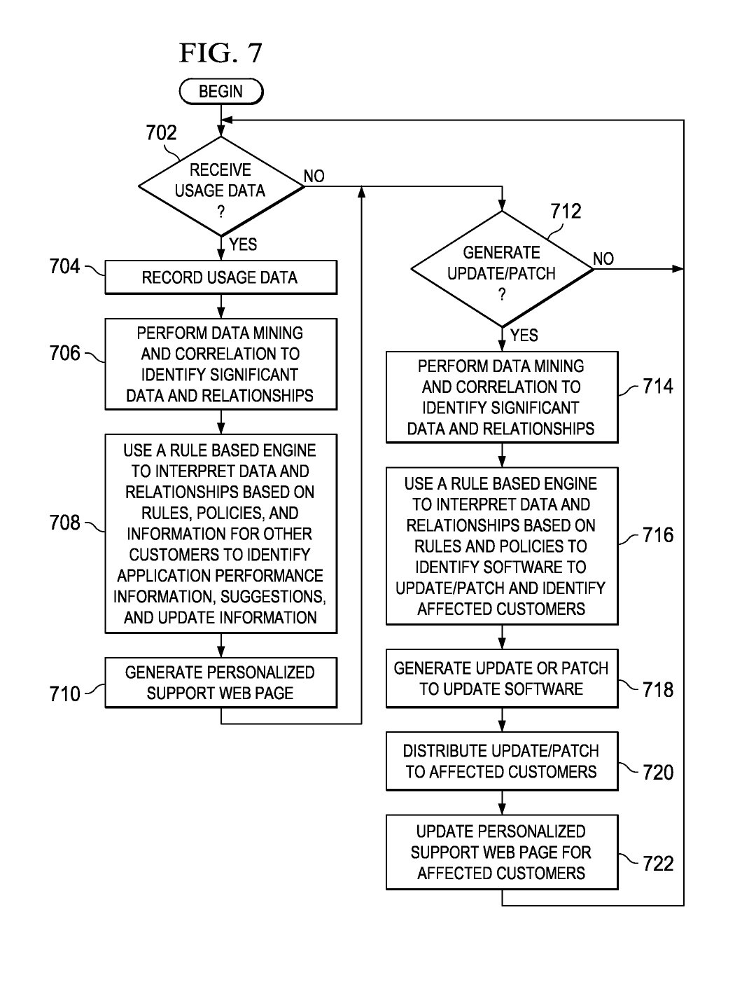

FIG. 7 is a flowchart illustrating operation of a support server in accordance with an illustrative embodiment. Operation begins, and the support server determines whether usage data is received from a software agent (block 702). If the support server determines that usage data is received, the support server records the usage data (block 704). Then, the support server performs data mining and correlation to identify significant data and relationships (block 706).

Next, the support server uses a rule based engine to interpret data and relationships based on rules, policies, and information for other customers to identify application performance information, suggestions, and update information (block 708). Then, the support server generates a personalized support Web page (block 710) based on this information. The support server may provide support for the customer from which usage data is received by generating or updating the personalized support Web page to include recommendations, references to a user or administrator guide, suggestions for training, references to forums on the Web where people are collaborating on the same topic of interest, and so forth. Thus, the support server may customize support based not only on the customer's own usage data, but on support provided to other customers. While the support server may customize support to one individual customer, the support server may also identify groups of customers who have similar patterns of usage or are experiencing the same errors or problems.

Thereafter, or if the support server does not receive usage data in block 702, the support server determines whether to generate an update or patch (block 712). The support server may determine that a developer accesses the support server to generate or distribute a patch or update. A developer may consult the support server periodically, such as once a week or month, to provide regular updates to the software product to ensure the customers always have a current version of the product. Alternatively, the support server may determine that certain critical errors or patterns of usage warrant a patch or update. If the support server determines not to generate an update or patch, operation returns to block 702 to determine whether usage data is being received.

If the support server determines that an update or patch is to be generated in block 712, the support server performs data mining and correlation to identify significant data and relationships (block 714). Then, the support server uses a rule based engine to interpret the usage data and relationships based on rules and policies to identify software to update or patch and identify affected customers (block 716). Next, the support server generates the update or patch to update the software product (block 718). The support server then distributes the update or patch to affected customers (block 720) and updates the personalized support Web pages of the affected customers to notify customers of the update or patch and other information relevant to the update or patch (block 722). Thereafter, operation returns to block 702 to determine whether usage data is being received.

Thus, the illustrative embodiments solve the disadvantages of the prior art by providing a proactive approach to software product support. A software agent gathers data concerning customer usage of a software product, including error information and other relevant information. A support server gathers customer usage data and determines which optional features of a product are being used, or not being used, by the customer. The developer may then determine what features and functionalities of a product are critical for each individual customer or group of customers. The support server may generate a personalized support system for each customer or group of customers based on the gathered information. Known bugs or fixes or added features may be proactively sent to customers before bugs and errors are reported on blogs and the like. The support server may create a segment of customers within vertical industry segments and target the customers with new and advanced features to help solve their individual business problems. Customers benefit by having fixes and features developed and distributed proactively. Customers may also get personalized support pages based on their usage data.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read-only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for providing personalized support, the method comprising:
receiving usage data from a customer of a software application;
analyzing the usage data based on a set of rules;
identifying a support action based on the analysis of the usage data; and
performing the identified support action based on the usage data.

2. The method of claim 1, wherein the usage data comprises at least one of file access information, feature access information, or error information.

3. The method of claim 1, wherein the support action comprises generating a software update.

4. The method of claim 3, wherein the software update comprises a patch.

5. The method of claim 3, wherein performing the support action comprises distributing the software update to the customer.

6. The method of claim 1, wherein the support action comprises generating a personalized support page.

7. The method of claim 6, wherein the personalized support page comprises a personalized support Web page, the method further comprising:
providing access to the personalized support Web page through a Web server.

8. The method of claim 6, wherein the personalized support page comprises information about at least one of alternative product features, appropriate parts of a user guide or administration guide, available user or application developer training, or related forums where people are collaborating on a same topic of interest.

9. The method of claim 1, wherein analyzing the usage data comprises performing data mining and correlation to identify significant data and relationships.

10. The method of claim 1, wherein identifying a support action comprises determining what features and functionalities of the software application are critical for an individual customer or group of customers.

11. The method of claim 1, wherein receiving usage data from a customer of a software application comprises:
receiving the usage data from a software agent associated with the software application.

12. A data processing system for providing personalized support, the data processing system comprising:
a processor; and
a memory coupled to the processor, wherein the memory contains instructions which, when executed by the processor, cause the processor to:
receive usage data from a customer of a software application;
analyze the usage data based on a set of rules;
identify a support action based on the analysis of the usage data; and
perform the identified support action based on the usage data.

13. The data processing system of claim 12, wherein the support action comprises generating a software update.

14. The data processing system of claim 13, wherein the software update comprises a patch.

15. The data processing system of claim 12, wherein the support action comprises generating a personalized support page.

16. The data processing system of claim 15, wherein the personalized support page comprises a personalized support Web page, wherein the instructions further cause the processor to:
provide access to the personalized support Web page through a Web server.

17. The data processing system of claim 12, wherein receiving usage data from a customer of a software application comprises:
receiving the usage data from a software agent associated with the software application.

18. A computer program product comprising a computer useable medium having a computer readable program, wherein the computer readable program, when executed on a computing device, causes the computing device to:
receive usage data from a customer of a software application;
analyze the usage data based on a set of rules;
identify a support action based on the analysis of the usage data; and
perform the identified support action based on the usage data.

19. The computer program product of claim 18, wherein the support action comprises generating a software update.

20. The computer program product of claim 18, wherein the support action comprises generating a personalized support page.
